(19) United States
(12) Patent Application Publication
(10) Pub. No.: US 2025/0293606 A1
(43) Pub. Date: Sep. 18, 2025

(54) CONTROL CIRCUIT OF FLYBACK CONVERTER WITH LOW CURRENT LOSS

(71) Applicant: Richtek Technology Corporation, Zhubei City (TW)

(72) Inventors: Yu-Meng LIN, Tainan City (TW); Li-Di LO, Zhudong Township (TW); Chien-Fu TANG, Hsinchu City (TW); Tzu-Chen LIN, Zhubei City (TW)

(21) Appl. No.: 19/049,277

(22) Filed: Feb. 10, 2025

Related U.S. Application Data
(60) Provisional application No. 63/565,054, filed on Mar. 14, 2024.

(30) Foreign Application Priority Data
Oct. 25, 2024 (TW) 113140854

(51) Int. Cl. H02M 3/335; H02M 1/00; H02M 1/32

(52) U.S. Cl. CPC H02M 3/33515; H02M 1/0025; H02M 1/32

(57) ABSTRACT

A control circuit adapted to a flyback converter includes a feedback circuit, a first current mirror, a second current mirror, a compensation resistor, and a pole adjuster. The feedback circuit generates a feedback current based on the output voltage from the flyback converter. The first current mirror maps the feedback current to a first mapping current. The second current mirror maps the first mapping current to a second mapping current. The compensation resistor is coupled to an internal node. The second mapping current flows through the compensation resistor to generate an internal voltage at the internal node. The pole adjuster generates a compensation voltage based on the internal voltage. The flyback converter raises the output power of the output voltage as the compensation voltage increases.

### CROSS REFERENCE TO RELATED APPLICATIONS

This application claims the benefit of U.S. Provisional Application No. 63/565,054, filed on Mar. 14, 2024, the entirety of which is incorporated by reference herein.

This application claims priority of Taiwan Patent Application No. 113140854, filed on Oct. 25, 2024, the entirety of which is incorporated by reference herein.

### BACKGROUND OF THE INVENTION

### Field of the Invention

The disclosure is generally related to a control circuit of a flyback converter, and more particularly it is related to a control circuit of a flyback converter with low current loss.

### Description of the Related Art

A flyback converter is a voltage converter that is derived from a buck-boost converter. After the inductor is replaced by a transformer with two coils, the output voltage is generated after rectification using a rectification unit (such as a diode). However, in order to accurately control the output voltage of the flyback converter, a closed-loop control must be utilized.

In a design of a flyback converter, a closed-loop control circuit often consumes some current. In order to increase the conversion efficiency of the flyback converter, the current consumption of the closed-loop control circuit must be reduced. However, reducing the current often produces other effects, which makes reducing the current consumption of the control circuit a huge challenge.

### BRIEF SUMMARY OF THE INVENTION

The present invention proposes a control circuit suitable for a flyback converter, which can reduce the current consumption of the control circuit and also maintain the stability of the control circuit at the same time. In addition, the control circuit proposed by the present invention can not only move the excessively low dominant pole to a high-frequency position, but it can also generate a new dominant pole with a pole adjuster, thereby making it easier to control the stability of the control circuit.

In an embodiment, a control circuit adapted to a flyback converter is provided. The control circuit comprises a feedback circuit, a first current mirror, a second current mirror, a compensation resistor, and a pole adjuster. The feedback circuit generates a feedback current based on an output voltage of the flyback converter. The first current mirror maps the feedback current to a first mapping current. The second current mirror maps the first mapping current to a second mapping current. The compensation resistor is coupled to an internal node. The second mapping current flows through the compensation resistor to generate an internal voltage at the internal node. The pole adjuster generates a compensation voltage based on the internal voltage. The flyback converter raises the output power of the output voltage as the compensation voltage increases.

According to an embodiment of the present invention, the pole adjuster comprises a pole resistor and a pole capacitor. The pole resistor is coupled between the internal node and the compensation voltage. The pole capacitor is coupled between the compensation voltage and a ground. The sum of a resistance of the compensation resistor and a resistance of the pole resistor and a capacitance of the pole capacitor determine a dominant pole of the control circuit.

According to an embodiment of the present invention, the first current mirror and the compensation resistor are coupled to a bias voltage. The second mapping current flows from the bias voltage to the internal node. The second current mirror is coupled to a ground.

According to an embodiment of the present invention, the control circuit further comprises an interconnect resistor. The interconnect resistor is coupled to the first current mirror. The feedback current flows through the interconnect resistor.

According to an embodiment of the present invention, the feedback circuit comprises a voltage divider, a regulation unit, a first resistor, and an optical coupler. The voltage divider divides the output voltage to generate a divided voltage. The regulation unit draws an optical-coupling current from an optical-coupling node based on the divided voltage. The first resistor is coupled to the output voltage. The optical-coupling current flows through the first resistor. The optical coupler is coupled between the first resistor and the optical-coupling node. The optical coupler generates the feedback current based on the optical-coupling current. The optical-coupling current increases as the divided voltage increases.

According to an embodiment of the present invention, the feedback circuit comprises a voltage divider, a first transconductance amplifier, a zero adjuster, a second transconductance amplifier, an optical coupler, and a second resistor. The voltage divider divides the output voltage to generate a divided voltage. The first transconductance amplifier compares the divided voltage with a reference voltage to generate a first current. The first current flows through the zero adjuster to generate a first voltage and a zero. The second transconductance amplifier generates an optical-coupling current based on the first voltage. The optical coupler generates the feedback current based on the optical-coupling current. The second resistor is coupled between the second transconductance amplifier and the optical coupler. The optical coupler flows through the second resistor.

According to an embodiment of the present invention, when the divided voltage exceeds the reference voltage, the first transconductance amplifier increases the first current. When the divided voltage does not exceed the reference voltage, the first transconductance amplifier decreases the first current.

According to an embodiment of the present invention, the zero adjuster comprises a zero resistor and a zero capacitor. The zero resistor is coupled to the first voltage. The zero capacitor is coupled between the first zero resistor and a ground. The zero is configured to improve the stability of the control circuit.

In another embodiment, a control circuit adapted to a flyback converter is provided. The control circuit comprises a first transistor, a feedback circuit, an amplifier, a first resistor, a first transconductance amplifier, and a second resistor. The first transistor comprises a gate terminal, a drain terminal, and a source terminal, where the gate terminal receives a control voltage. The feedback circuit draws a feedback current from the source terminal based on an output voltage of the flyback converter. The amplifier comprises a positive terminal, a negative terminal, and an output terminal, where the positive terminal receives a first reference voltage, the negative terminal is coupled to the source terminal, and the output terminal generates the control voltage. The first resistor is coupled between a bias voltage and the drain terminal. The first transconductance amplifier generates a first current based on a voltage difference between two terminals of the first resistor. The second resistor is coupled between the bias voltage and a compensation voltage. The first current flows through the second resistor to generate the compensation voltage. The flyback converter raises the output power of the output voltage based on the increase in the compensation voltage.

According to an embodiment of the present invention, the feedback circuit comprises a voltage divider, a regulation unit, a third resistor, and an optical coupler. The voltage divider divides the output voltage to generate a divided voltage. The regulation unit draws an optical-coupling current from an optical-coupling node based on the divided voltage. The third resistor is coupled to the output voltage, where the optical-coupling current flows through the third resistor. The optical coupler is coupled between the third resistor and the optical coupler. The optical coupler generates the feedback current based on the optical-coupling current. The optical-coupling current increases as the divided voltage increases.

According to an embodiment of the present invention, the feedback circuit comprises a divided circuit, a second transconductance amplifier, a zero adjuster, a third transconductance amplifier, an optical coupler, and a fourth resistor. The divided circuit divides the output voltage to generate a divided voltage. The second transconductance amplifier compares the divided voltage with a second reference voltage to generate a first current. The first current flows through the zero adjuster to generate a first voltage and a zero. The third transconductance amplifier generates an optical-coupling current based on the first voltage. The optical coupler generates the feedback current based on the optical-coupling current. The fourth resistor is coupled between the second transconductance amplifier and the optical coupler. The zero is configured to improve the stability of the control circuit.

According to an embodiment of the present invention, when the divided voltage exceeds the reference voltage, the first transconductance amplifier increases the first current. When the divided voltage does not exceed the reference voltage, the first transconductance amplifier decreases the first current.

In yet another embodiment, a control circuit adapted to a flyback converter is provided. The control circuit comprises a feedback circuit, a first current mirror, a second current mirror, a compensation resistor, and a pole adjuster. The feedback circuit generates an optical-coupling current based on an output voltage of the flyback converter, where the feedback circuit further comprises an optical coupler. The optical coupler generates the feedback current based on the optical-coupling current. The first current mirror maps the feedback current to a first mapping current. The second current mirror maps the first mapping current to a second mapping current. The compensation resistor is coupled to an internal node, where the second mapping current flows through the internal resistor to generate an internal voltage at the internal node. The pole adjuster generates a compensation voltage based on the internal voltage. The flyback converter raises the output power of the output voltage based on the increase in the compensation voltage.

According to an embodiment of the present invention, the pole adjuster comprises a pole resistor and a pole capacitor. The pole resistor is coupled between the first node and the compensation voltage. The pole capacitor is coupled between the compensation voltage and a ground. The capacitance of the pole capacitor and the sum of the resistance of the pole resistor and the resistance of the compensation resistor determine a dominant pole of the control circuit.

According to an embodiment of the present invention, the first current mirror and the first resistor are both coupled to a bias voltage. The second mapping current flows from the bias voltage to the first node. The second current mirror is coupled to a ground.

According to an embodiment of the present invention, the control circuit further comprises an interconnect resistor. The interconnect resistor is coupled to the first current mirror. The feedback current flows through the interconnect resistor.

According to an embodiment of the present invention, the feedback circuit comprises a voltage divider, a regulation unit, and a first resistor. The voltage divider divides the output voltage to generate a divided voltage. The regulation unit draws the optical-coupling current from an optical-coupling node based on the divided voltage. The first resistor is coupled to the output voltage. The optical-coupling current flows through the first resistor. The optical coupler is coupled between the optical-coupling node and the first resistor. The optical-coupling current increases as the divided voltage increases.

According to an embodiment of the present invention, the feedback circuit comprises a voltage divider, a first transconductance amplifier, a zero adjuster, a second transconductance amplifier, and a second resistor. The voltage divider divides the output voltage to generate a divided voltage. The first transconductance amplifier compares the divided voltage with a reference voltage to generate a first current. The first current flows through the zero adjuster to generate a first voltage and a zero. The second transconductance amplifier generates the optical-coupling current based on the first voltage. The second resistor is coupled between the second transconductance and the optical coupler. The optical-coupling current flows through the second resistor.

According to an embodiment of the present invention, when the divided voltage exceeds the reference voltage, the first transconductance amplifier increases the first current. When the divided voltage does not exceed the reference voltage, the first transconductance amplifier decreases the first current.

According to an embodiment of the present invention, the zero adjuster comprises a zero resistor and a zero capacitor. The zero resistor is coupled to the first voltage. The zero capacitor is coupled between the first zero resistor and a ground. The zero is configured to improve the stability of the control circuit.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1A is a block diagram of a flyback converter in accordance with an embodiment of the present invention;

FIG. 1B is a block diagram showing a flyback converter in accordance with another embodiment of the present invention;

FIG. 2 is a circuit diagram showing a control circuit in accordance with an embodiment of the present invention;

FIG. 3 is a circuit diagram showing a control circuit in accordance with another embodiment of the present invention;

FIG. 4 is a circuit diagram showing a control circuit in accordance with another embodiment of the present invention;

FIG. 5 is a circuit diagram showing a control circuit in accordance with another embodiment of the present invention;

FIG. 6 is a circuit diagram showing a control circuit in accordance with another embodiment of the present invention;

FIG. 7 is a circuit diagram showing a control circuit in accordance with another embodiment of the present invention; and

FIG. 8 is a circuit diagram showing a control circuit in accordance with another embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

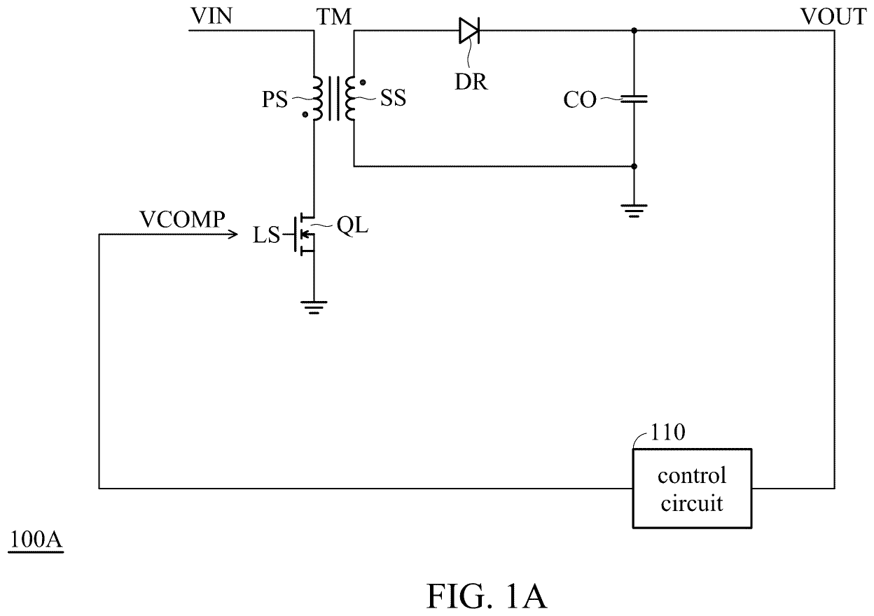

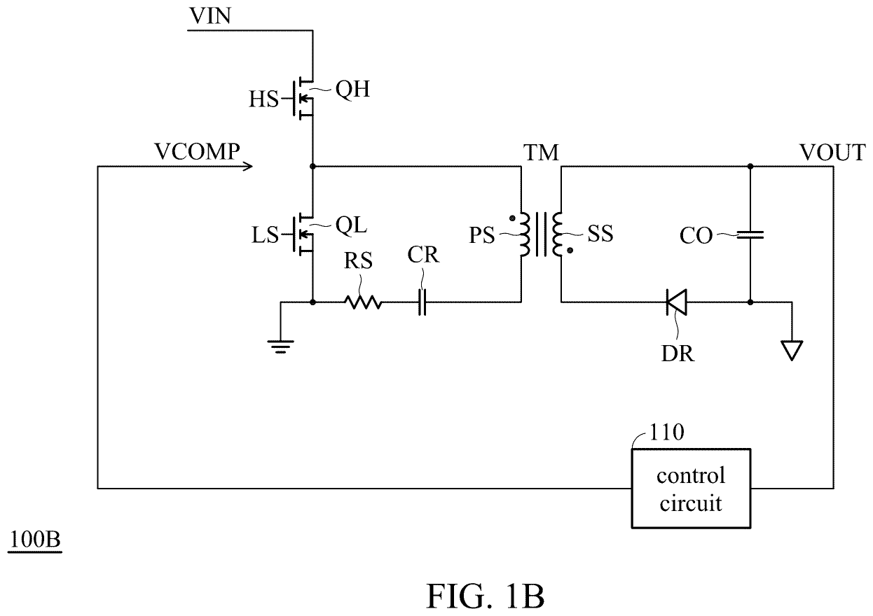

FIG. 1A is a block diagram of a flyback converter in accordance with an embodiment of the present invention. As shown in FIG. 1A, the flyback converter 100A includes a low-side transistor QL, a transformer TM, an output capacitor CO, a rectification unit DR, and a control circuit 110. When the low-side transistor QL is turned on based on the low-side driving signal LS, the input voltage VIN stores energy in the transformer TM. When the low-side transistor QL is turned off, the transformer TM releases energy. The transformer TM includes a primary coil PS and a secondary coil SS, wherein the primary coil PS is electrically connected to the low-side transistor QL.

The output capacitor CO is coupled to both terminals of the secondary coil SS, and the rectifier element DR is coupled between the output capacitor CO and the secondary coil SS, thereby converting the energy stored in the transformer TM into the output voltage VOUT. The control circuit 110 is configured to generate a compensation voltage VCOMP based on the output voltage VOUT.

According to one embodiment of the present invention, when the compensation voltage VCOMP increases, the flyback converter 100A increases the output power of the output voltage VOUT by using the low-side driving signal LS. According to another embodiment of the present invention, when the compensation voltage VCOMP decreases, the flyback adapter 100A reduces the output power of the output voltage VOUT by using the low-side driving signal LS.

FIG. 1B is a block diagram showing a flyback converter in accordance with another embodiment of the present invention. As shown in FIG. 1B, the flyback converter 100B includes a high-side transistor QH, a low-side transistor QL, a transformer TM, a resonant capacitor CR, a detection resistor RS, an output capacitor CO, a rectification unit DR, and a control circuit 110. The high-side transistor HS charges the transformer TM and the resonant capacitor CR using the input voltage VIN based on the high-side driving signal HS. The low-side transistor LS discharges the transformer TM and the resonant capacitor CR based on the low-side driving signal LS.

The transformer TM includes a primary coil PS and a secondary coil SS, where the primary coil PS is electrically connected to the high-side transistor HS and the low-side transistor QL. The resonant capacitor CR is coupled to the transformer TM, and the detection resistor RS is used to detect the magnitude of the current flowing through the primary coil PS and the resonant capacitor CR.

The output capacitor CO is coupled to both terminals of the secondary coil SS. The rectification unit DR is coupled between the output capacitor CO and the secondary coil SS, thereby converting the energy stored in the transformer TM into the output voltage UT. The control circuit 110 is configured to generate a compensation voltage VCOMP based on the output voltage VOUT.

According to one embodiment of the present invention, when the compensation voltage VCOMP increases, the flyback converter 100B increases the output power of the output voltage VOUT by using the high-side driving signal HS and the low-side driving signal LS. According to another embodiment of the present invention, when the compensation voltage VCOMP decreases, the flyback converter 100B reduces the output power of the output voltage VOUT by using the high-side driving signal HS and the low-side driving signal LS. According to an embodiment of the present invention, the flyback converter 100B is an asymmetrical half-bridge flyback converter.

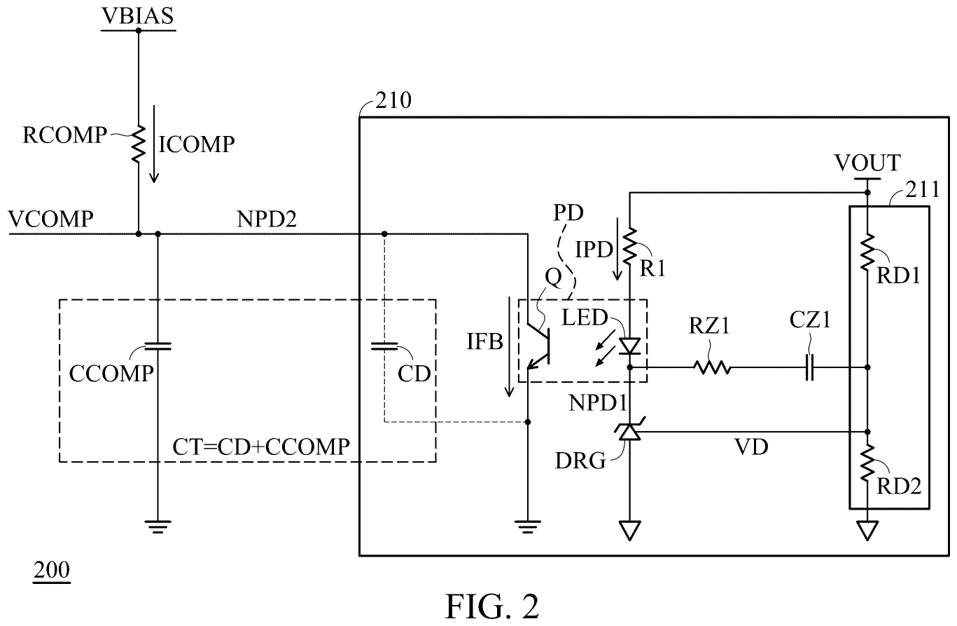

FIG. 2 is a circuit diagram showing a control circuit in accordance with an embodiment of the present invention. According to an embodiment of the present invention, the control circuit 200 may correspond to the control circuit 110 of FIG. 1A and FIG. 1B. As shown in FIG. 2, the control circuit 200 includes a feedback circuit 210, a compensation resistor RCOMP, and a compensation capacitor CCOMP. The feedback circuit 210 includes a voltage divider 211, a rectification unit DR, a first resistor R1, an optical coupler PD, a first zero resistor RZ1, and a first zero capacitor CZ1.

The voltage divider 211 includes a first voltage-dividing resistor RD1 and a second voltage-dividing resistor RD2 for dividing the output voltage VOUT to generate a divided voltage VD. The regulation unit DRG extracts the optical-coupling current IPD from the first optical-coupling node NPD1 based on the divided voltage VD. According to some embodiments of the present invention, the v regulation unit DRG may be TL431. According to an embodiment of the present invention, when the divided voltage VD increases, the optical-coupling current IPD increases. According to another embodiment of the present invention, when the divided voltage VD decreases, the optical-coupling current IPD decreases. The first resistor R1 is coupled to the output voltage VOUT, and the optical-coupling current IPD flows through the first resistor R1.

The optical coupler PD draws a feedback current IFB from the second optical-coupling node NPD2 based on the optical-coupling current IPD. The optical coupler PD includes a light emitting diode LED and a transistor Q, where the light emitting diode LED is coupled between the first resistor R1 and an optical-coupling node NPD, and the optical-coupling current IPD flows through the light emitting diode LED. When the optical-coupling current IPD flows through the light emitting diode LED to make the light emitting diode LED emit light, the light generated by the light emitting diode LED causes the transistor Q to draw a feedback current IFB from the second optical-coupling node NPD2, where the feedback current IFB is positively correlated with the optical-coupling current IPD.

According to some embodiments of the present invention, the ground coupled to the light emitting diode LED of the optical coupler PD and the ground coupled to the transistor Q are electrically separated from each other. The first zero resistor RZ1 and the first zero capacitor CZ1 are connected in series between the first optical-coupling node NPD1 and the divided voltage VD to generate a zero to stabilize the control circuit 200.

As shown in FIG. 2, the control circuit 200 further includes a compensation resistor RCOMP and a compensation capacitor CCOMP. The compensation resistor RCOMP is coupled between the bias voltage VBIAS and the compensation voltage VCOMP, the compensation capacitor CCOMP is coupled between the compensation voltage VCOMP and the ground terminal, and the compensation current ICOMP flows through the compensation resistor RCOMP. The compensation voltage VCOMP s electrically connected to the second optical-coupling node NPD2.

According to one embodiment of the present invention, the dominant pole of the output voltage VOUT to the compensation voltage VCOMP is determined by the compensation resistor RCOMP and the total capacitor CT, and the zero generated by the sum of the voltage-dividing resistors RD1 and the first zero resistor RZ1 and the first zero capacitor CZ1 is used to maintain loop stability, where the total capacitance CT is equal to the sum of the compensation capacitance CCOMP and the parasitic capacitance CD of the transistor Q. According to an embodiment of the present invention, the sum of the first zero capacitor CZ1 and the sum of the first zero resistor RZ1 and the first voltage-dividing resistor RD1 determines the position of the zero.

According to one embodiment of the present invention, in order to reduce the current consumption of the control circuit 200, the compensation resistor RCOMP must be increased to reduce the compensation current ICOMP. However, the increased compensation resistor RCOMP causes the dominant pole to move to a lower frequency position, and the increased compensation resistor RCOMP also increases the gain of the output voltage VOUT to the compensation voltage VCOMP. Therefore, it is necessary to do something to ensure the stability of the control circuit 200.

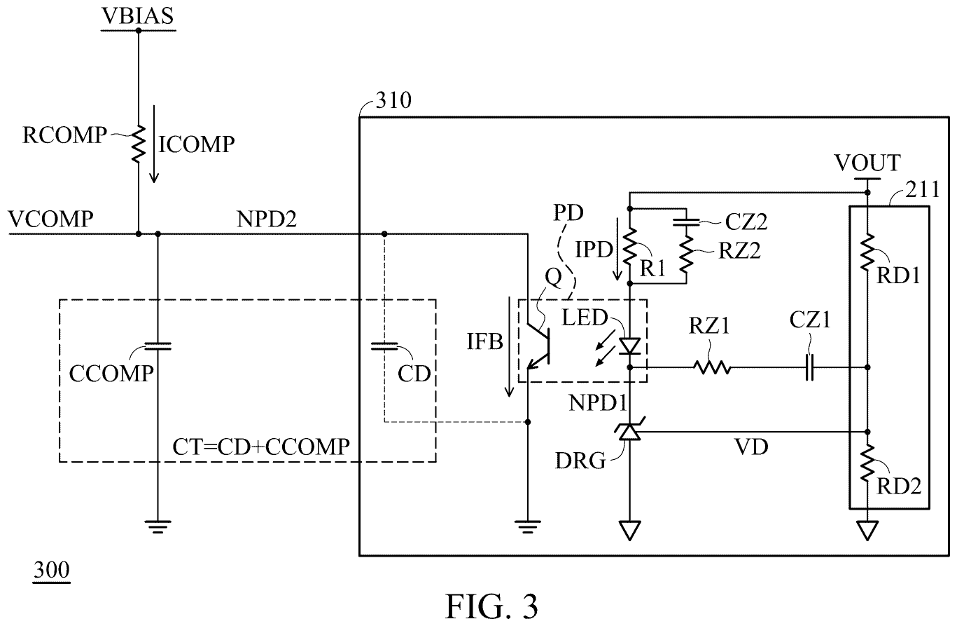

FIG. 3 is a circuit diagram showing a control circuit in accordance with another embodiment of the present invention. Comparing the control circuit 300 of FIG. 3 with the control circuit 200 of FIG. 2, the feedback circuit 310 of the control circuit 300 further includes a second zero resistor RZ2 and a second zero capacitor CZ2, where the second zero resistor RZ2 and the second zero capacitor CZ2 is connected in series between the output voltage VOUT and the light-emitting diode LED of the optical coupler PD.

According to one embodiment of the present invention, reducing the feedback current IFB helps to reduce the optical-coupling current IPD, thereby reducing the current consumption of the control circuit 300 to improve the conversion efficiency. As the feedback current IFB decreases, the compensation current ICOMP also decreases, causing the compensation resistor RCOMP to increase, so that the dominant pole generated by the compensation resistor RCOMP moves toward lower frequency, causing the control circuit 300 to be unstable. The second zero capacitor CZ2 and the sum of the first resistor R1 and the second zero resistor RZ2 are configured to generate an additional zero to compensate for the phase shift caused by the increased compensation resistor RCOMP, so as to ensure the stability of the control circuit 300.

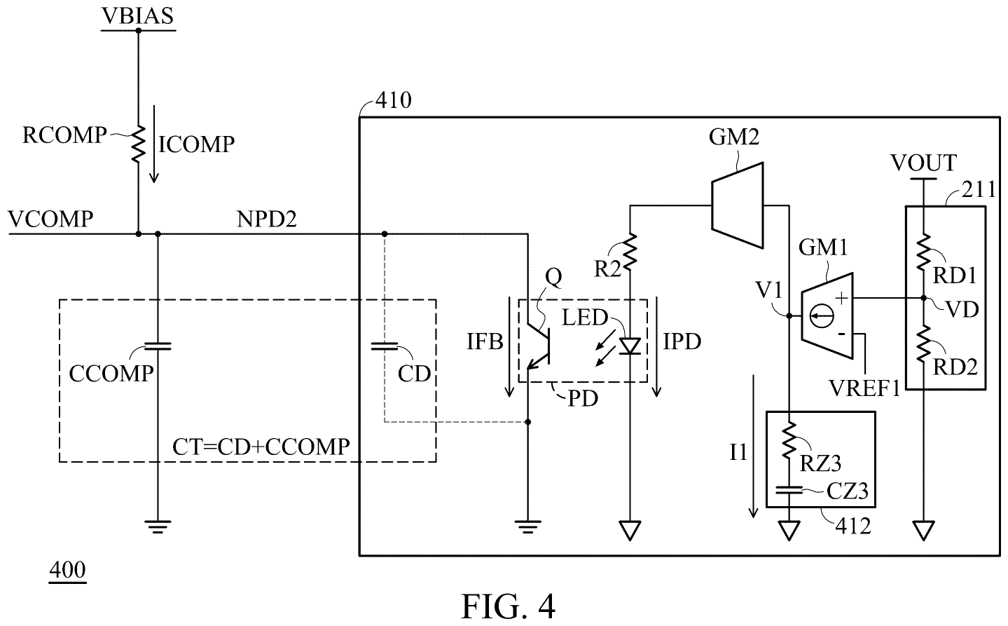

FIG. 4 is a circuit diagram showing a control circuit in accordance with another embodiment of the present invention. Comparing the control circuit 400 of FIG. 4 with the control circuit 200 of FIG. 2, the feedback circuit 210 of FIG. 2 is replaced by a feedback circuit 410. As shown in FIG. 4, the feedback circuit 410 includes a voltage divider 211, a first transconductance amplifier GM1, a zero adjuster 412, a second transconductance amplifier GM2, a second resistor R2, and an optical coupler PD.

The voltage divider 211 is configured to divide the output voltage VOUT to generate a divided voltage VD. The first transconductance amplifier GM1 generates a first current I1 based on a difference between the divided voltage VD and the first reference voltage VREF1. In addition, the first current I1 flows through the zero adjuster 412 to generate a first voltage V1.

As shown in FIG. 4, the zero adjuster 412 includes a third zero resistor RZ3 and a third zero capacitor CZ3, where the third zero resistor RZ3 and the third zero capacitor CZ3 are connected in series to the first voltage V1 and the ground, and the first current I1 flows through the third zero resistor RZ3 and the third zero capacitor CZ3. Next, the second transconductance amplifier GM2 generates the optical-coupling current IPD based on the first voltage V1.

The optical coupler PD generates a feedback current IFB flowing through the transistor Q from the second optical-coupling node NPD2 based on the optical-coupling current IPD flowing through the light emitting diode LED. As shown in FIG. 4, the control circuit 400 further includes a compensation resistor RCOMP and a compensation capacitor CCOMP, where the compensation resistor RCOMP is coupled between the bias voltage VBIAS and the compensation voltage VCOMP, and the compensation capacitor CCOMP is coupled between the compensation voltage VCOMP and the ground.

According to one embodiment of the present invention, the dominant pole of the control circuit 400 is determined by the compensation resistor RCOMP and the sum of the compensation capacitor CCOMP and the parasitic capacitance CD of the transistor Q. The third zero resistor RZ3 and the third zero capacitor CZ3 are configured to determine the zero, thereby controlling the stability of the control circuit 400. In order to reduce the current consumption of the control circuit 400, the compensation current ICOMP may be reduced by increasing the compensation resistor RCOMP. However, the increase of the compensation resistor RCOMP will cause the dominant pole to move toward lower frequency, causing the control circuit 400 to be unstable.

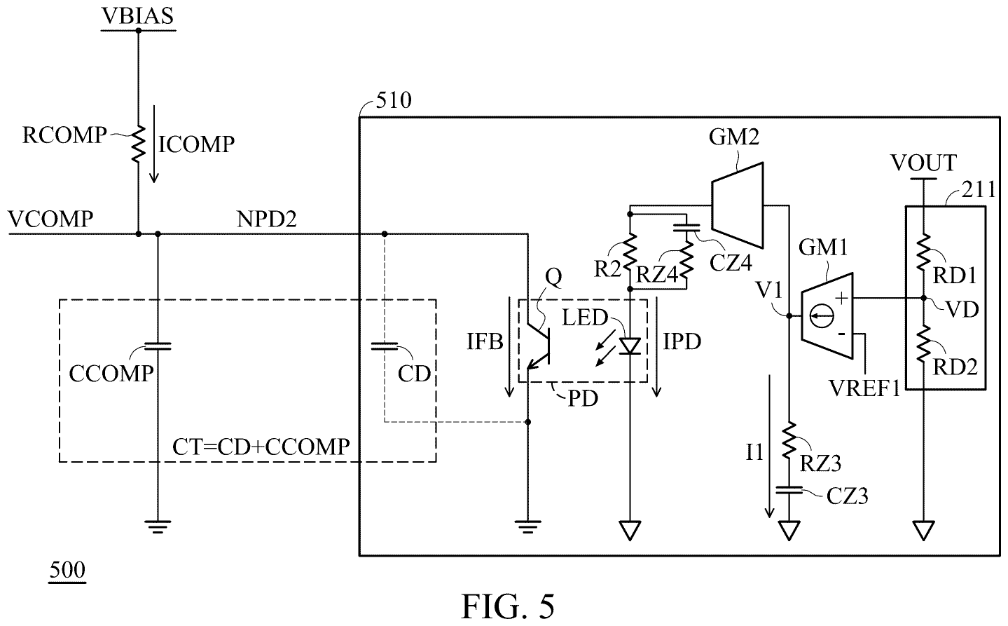

FIG. 5 is a circuit diagram showing a control circuit in accordance with another embodiment of the present invention. Comparing the control circuit 500 of FIG. 5 with the control circuit 400 of FIG. 4, the feedback circuit 510 further includes a fourth zero resistor RZA and a fourth zero capacitor CZA compared to the feedback circuit 410. The fourth zero resistor RZ4 and the fourth zero capacitor CZA are connected in series between the second transconductance amplifier GM2 and the light-emitting diode LED of the optical coupler PD, and also connected in parallel with the second resistor R2.

According to one embodiment of the present invention, the fourth zero capacitor CZ4 and the sum of the fourth zero resistor RZA and the second resistor R2 determine an additional zero to compensate for dominant pole moving toward lower frequency derived by the compensation resistor RCOMP increased to reduce the compensation current ICOMP, thereby increasing the stability of the control circuit 500.

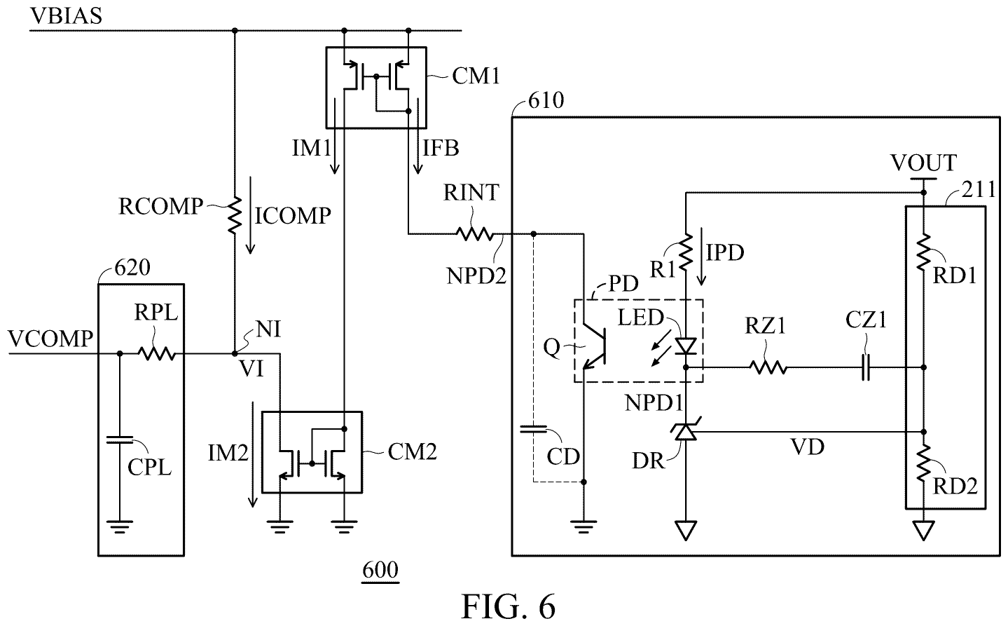

FIG. 6 is a circuit diagram showing a control circuit in accordance with another embodiment of the present invention. As shown in FIG. 6, the control circuit 600 includes a feedback circuit 610, a first current mirror CM1, an interconnect resistor RINT, a second current mirror CM2, a compensation resistor RCOMP, and a pole adjuster 620. The feedback circuit 610 is identical to the feedback circuit 210 in FIG. 2, which will not be repeated herein.

The first current mirror CM1 is coupled to the bias voltage VBIAS to map the feedback current IFB into the first mapped current IM1. The interconnect resistor RINT is coupled between the first current mirror CM1 and the transistor Q of the optical coupler PD. According to an embodiment of the present invention, the interconnect resistor RINT and the first current mirror CM1 are configured to move the pole generated at the second optical-coupling node NPD2 (as shown in FIGS. 2 and 3) to a very high frequency position. According to other embodiments of the present invention, the interconnect resistor RINT may also be omitted.

The second current mirror CM2 is coupled to the ground and is configured to map the first mapped current IM1 into the second mapped current IM2. The compensation resistor RCOMP is coupled between the bias voltage VBIAS and the internal node NI, and the compensation current ICOMP flows through the compensation resistor RCOMP, where the second current mirror CM2 draws the second mirror current IM2 from the internal node NI.

The pole adjuster 620 is coupled between the internal node NI and the compensation voltage VCOMP, and generates the compensation voltage VCOMP based on the internal voltage VI of the internal node NI. The pole adjuster 620 includes a pole resistor RPL and a pole capacitor CPL, where the pole resistor RPL is coupled between the internal node NI and the compensation voltage VCOMP, and the pole capacitor CPL is coupled between the compensation voltage VCOMP and the ground. According to an embodiment of the present invention, when the pole resistor RPL is significant, the compensation current ICOMP is equal to the second mapping current IM2.

According to one embodiment of the present invention, the pole capacitor CPL and the sum of the pole resistor RPL and the compensation resistor RCOMP are configured to determine the dominant pole of the control circuit 600. In other words, when the compensation resistor RCOMP is increased to reduce the current consumption of the control circuit 600, the dominant pole of the control circuit 600 can be moved to a higher frequency by reducing the capacitance of the pole capacitor CPL, thereby increasing the stability of the control circuit 600.

In other words, when comparing the control circuit 600 of FIG. 6 with the control circuit 300 of FIG. 3, the control circuit 600 utilizes the first current mirror CM1, the connecting resistor RINT, and the second current mirror CM2 to move the pole of the second optical-coupling node NPD2 to a very high frequency position, and then the pole adjuster 620 is used to generate a suitable dominant pole. Therefore, the control circuit 600 obtains sufficient phase margin without the second zero resistor RZ2 and the second zero capacitor CZ2 in FIG. 3, thereby ensuring the stability of the control circuit 600.

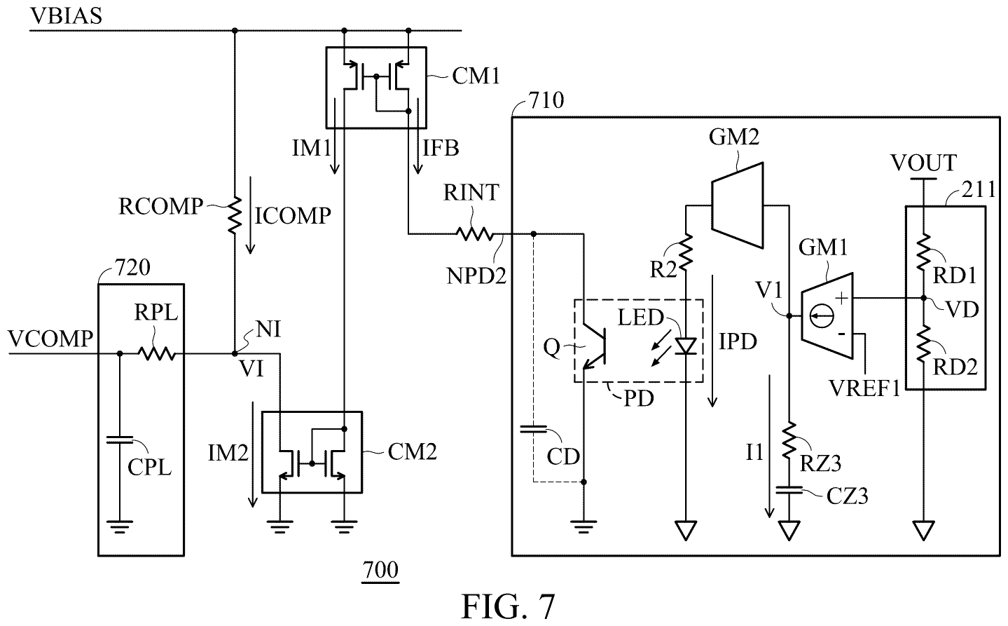

FIG. 7 is a circuit diagram showing a control circuit in accordance with another embodiment of the present invention. As shown in FIG. 7, the control circuit 700 includes a feedback circuit 710, a first current mirror CM1, a connecting resistor RINT, a second current mirror CM2, a compensation resistor RCOMP, and a pole adjuster 720, where the feedback circuit 710 is identical to the fourth feedback circuit 410 in FIG. 4, which will not be repeated herein.

In addition, the first current mirror CM1, the interconnect resistor RINT, the second current mirror CM2, the compensation resistor RCOMP, and the pole adjuster 720 of FIG. 7 are identical to the first current mirror CM1, the interconnect resistor RINT, the second current mirror CM2, the compensation resistor RCOMP and the pole adjuster 720 of FIG. 6 respectively, which will not be repeated herein.

According to one embodiment of the present invention, the dominant pole of the control circuit 400 of FIG. 4 is formed at the second optical-coupling node NPD2, the first current mirror CM1 of FIG. 7 and the interconnect resistor RINT move the pole at the second optical-coupling node NPD2 to a very high frequency position, and a suitable dominant pole is generated by the pole adjuster 720, thereby improving the stability of the control circuit 700.

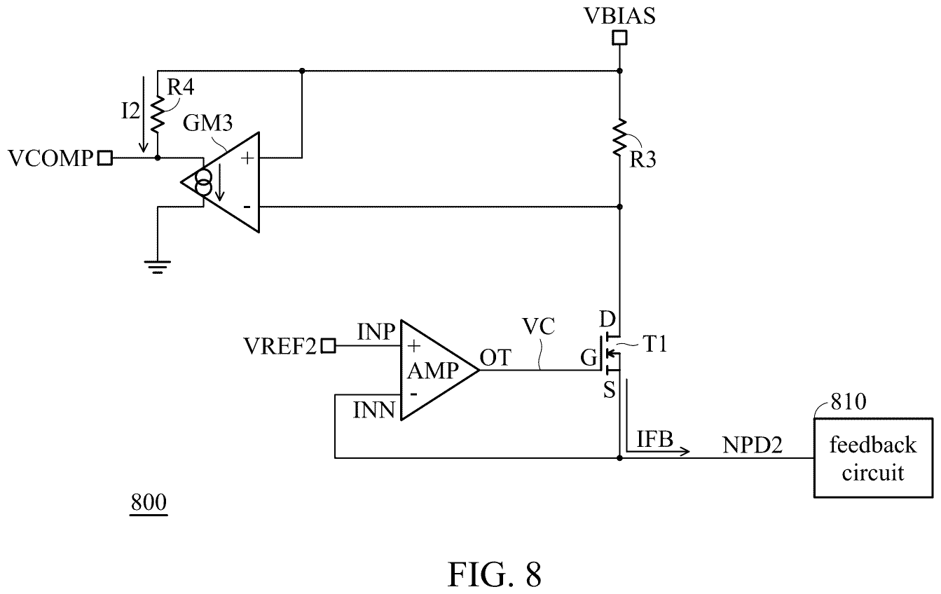

FIG. 8 is a circuit diagram showing a control circuit in accordance with another embodiment of the present invention. As shown in FIG. 8, the control circuit 800 includes a feedback circuit 810, a first transistor T1, an amplifier AMP, a third resistor R3, a third transconductance amplifier GM3, and a fourth resistor R4. According to an embodiment of the present invention, the feedback circuit 810 may be the feedback circuit 210 of FIG. 2, and is configured to draw the feedback current IFB from the second optical-coupling node NPD2. According to another embodiment of the present invention, the feedback circuit 810 may be the feedback circuit 410 of FIG. 4, and is configured to draw the feedback current IFB from the second optical-coupling node NPD2.

The first transistor T1 includes a drain terminal D, a source terminal S, and a gate terminal G, where the gate terminal G receives a control voltage VC, and the source terminal S is coupled to the second optical-coupling node NPD2. The amplifier AMP includes a positive input terminal INP, a negative input terminal INN, and an output terminal OT, where the negative input terminal INN is coupled to the source terminal S, the positive input terminal INP receives the second reference voltage VREF2, and the output terminal OT generates a control voltage VC, thereby controlling the first transistor T1. The third resistor R3 is coupled between the bias voltage VBIAS and the drain terminal D.

The third transconductance amplifier GM3 generates a second current I2 based on the voltage difference between the two terminals of the third resistor R3. The fourth resistor R4 is coupled between the bias voltage VBIAS and the compensation voltage VCOMP, where the second current I2 flows from the bias voltage VBIAS to the compensation voltage VCOMP through the fourth resistor R4. According to an embodiment of the present invention, the dominant pole of the control circuit 800 is located at the second optical-coupling node NPD2.

According to one embodiment of the present invention, when the feedback current IFB decreases, the resistance value of the third resistor R3 increases accordingly. Since the source terminal S of the first transistor T1 is a low impedance node and is coupled to the second optical-coupling node NPD2, even if the third resistor R3 increases as the feedback current IFB decreases, the pole of the second optical-coupling node NPD2 in FIG. 8 is still maintained at a very high frequency position.

The present invention proposes a control circuit suitable for a flyback converter, which can reduce the current consumption of the control circuit and also maintain the stability of the control circuit at the same time. In addition, the control circuit proposed by the present invention can not only move the excessively low dominant pole to a high-frequency position, but it can also generate a new dominant pole with a pole adjuster, thereby making it easier to control the stability of the control circuit.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A control circuit adapted to a flyback converter, comprising:
a feedback circuit, generating a feedback current based on an output voltage of the flyback converter;
a first current mirror, mapping the feedback current to a first mapping current;
a second current mirror, mapping the first mapping current to a second mapping current;
a compensation resistor, coupled to an internal node, wherein the second mapping current flows through the compensation resistor to generate an internal voltage at the internal node; and
a pole adjuster, generating a compensation voltage based on the internal voltage;
wherein the flyback converter raises output power of the output voltage as the compensation voltage increases.

2. The control circuit as claimed in claim 1, wherein the pole adjuster comprises:
a pole resistor, coupled between the internal node and the compensation voltage; and
a pole capacitor, coupled between the compensation voltage and a ground;
wherein a sum of a resistance of the compensation resistor and a resistance of the pole resistor and a capacitance of the pole capacitor determine a dominant pole of the control circuit.

3. The control circuit as claimed in claim 1, wherein the first current mirror and the compensation resistor are coupled to a bias voltage;
wherein the second mapping current flows from the bias voltage to the internal node;
wherein the second current mirror is coupled to a ground.

4. The control circuit as claimed in claim 1, further comprising:
an interconnect resistor, coupled to the first current mirror;
wherein the feedback current flows through the interconnect resistor.

5. The control circuit as claimed in claim 4, wherein the feedback circuit comprises:
a voltage divider, dividing the output voltage to generate a divided voltage;
a regulation unit, drawing an optical-coupling current from an optical-coupling node based on the divided voltage;
a first resistor, coupled to the output voltage, wherein the optical-coupling current flows through the first resistor; and
an optical coupler, coupled between the first resistor and the optical-coupling node;
wherein the optical coupler generates the feedback current based on the optical-coupling current;
wherein the optical-coupling current increases as the divided voltage increases.

6. The control circuit as claimed in claim 4, wherein the feedback circuit comprises:
a voltage divider, dividing the output voltage to generate a divided voltage;
a first transconductance amplifier, comparing the divided voltage with a reference voltage to generate a first current;
a zero adjuster, wherein the first current flows through the zero adjuster to generate a first voltage and a zero;
a second transconductance amplifier, generating an optical-coupling current based on the first voltage;
an optical coupler, generating the feedback current based on the optical-coupling current; and
a second resistor, coupled between the second transconductance amplifier and the optical coupler;
wherein the optical coupler flows through the second resistor.

7. The control circuit as claimed in claim 6, wherein when the divided voltage exceeds the reference voltage, the first transconductance amplifier increases the first current;
wherein when the divided voltage does not exceed the reference voltage, the first transconductance amplifier decreases the first current.

8. The control circuit as claimed in claim 6, wherein the zero adjuster comprises:
a zero resistor, coupled to the first voltage; and
a zero capacitor, coupled between the first zero resistor and a ground;
wherein the zero is configured to improve stability of the control circuit.

9. A control circuit adapted to a flyback converter, comprising:
a first transistor, comprising a gate terminal, a drain terminal, and a source terminal, wherein the gate terminal receives a control voltage;
a feedback circuit, drawing a feedback current from the source terminal based on an output voltage of the flyback converter;
an amplifier, comprising a positive terminal, a negative terminal, and an output terminal, wherein the positive terminal receives a first reference voltage, the negative terminal is coupled to the source terminal, and the output terminal generates the control voltage;
a first resistor, coupled between a bias voltage and the drain terminal;
a first transconductance amplifier, generating a first current based on a voltage difference between two terminals of the first resistor; and
a second resistor, coupled between the bias voltage and a compensation voltage;
wherein the first current flows through the second resistor to generate the compensation voltage;
wherein the flyback converter raises output power of the output voltage based on the increase in the compensation voltage.

10. The control circuit as claimed in claim 9, wherein the feedback circuit comprises:
a voltage divider, dividing the output voltage to generate a divided voltage;
a regulation unit, drawing an optical-coupling current from an optical-coupling node based on the divided voltage;
a third resistor, coupled to the output voltage, wherein the optical-coupling current flows through the third resistor; and
an optical coupler, coupled between the third resistor and the optical coupler;
wherein the optical coupler generates the feedback current based on the optical-coupling current;
wherein the optical-coupling current increases as the divided voltage increases.

11. The control circuit as claimed in claim 9, wherein the feedback circuit comprises:
a divided circuit, dividing the output voltage to generate a divided voltage;
a second transconductance amplifier, comparing the divided voltage with a second reference voltage to generate a first current;
a zero adjuster, wherein the first current flows through the zero adjuster to generate a first voltage and a zero;
a third transconductance amplifier, generating an optical-coupling current based on the first voltage;
an optical coupler, generating the feedback current based on the optical-coupling current; and
a fourth resistor, coupled between the second transconductance amplifier and the optical coupler;
wherein the zero is configured to improve stability of the control circuit.

12. The control circuit as claimed in claim 11, wherein when the divided voltage exceeds the reference voltage, the first transconductance amplifier increases the first current;
wherein when the divided voltage does not exceed the reference voltage, the first transconductance amplifier decreases the first current.

13. A control circuit adapted to a flyback converter, comprising:
a feedback circuit, generating an optical-coupling current based on an output voltage of the flyback converter, wherein the feedback circuit further comprises:
an optical coupler, generating the feedback current based on the optical-coupling current;
a first current mirror, mapping the feedback current to a first mapping current;
a second current mirror, mapping the first mapping current to a second mapping current;
a compensation resistor, coupled to an internal node, wherein the second mapping current flows through the internal resistor to generate an internal voltage at the internal node; and
a pole adjuster, generating a compensation voltage based on the internal voltage;
wherein the flyback converter raises output power of the output voltage based on the increase in the compensation voltage.

14. The control circuit as claimed in claim 13, wherein the pole adjuster comprises:
a pole resistor, coupled between the first node and the compensation voltage; and
a pole capacitor, coupled between the compensation voltage and a ground;
wherein a capacitance of the pole capacitor and a sum of a resistance of the pole resistor and a resistance of the compensation resistor determine a dominant pole of the control circuit.

15. The control circuit as claimed in claim 13, wherein the first current mirror and the first resistor are both coupled to a bias voltage;
wherein the second mapping current flows from the bias voltage to the first node;
wherein the second current mirror is coupled to a ground.

16. The control circuit as claimed in claim 13, further comprising:
an interconnect resistor, coupled to the first current mirror;
wherein the feedback current flows through the interconnect resistor.

17. The control circuit as claimed in claim 16, wherein the feedback circuit comprises:
a voltage divider, dividing the output voltage to generate a divided voltage;
a regulation unit, drawing the optical-coupling current from an optical-coupling node based on the divided voltage; and
a first resistor, coupled to the output voltage, wherein the optical-coupling current flows through the first resistor;
wherein the optical coupler is coupled between the optical-coupling node and the first resistor;
wherein the optical-coupling current increases as the divided voltage increases.

18. The control circuit as claimed in claim 16, wherein the feedback circuit comprises:
a voltage divider, dividing the output voltage to generate a divided voltage;
a first transconductance amplifier, comparing the divided voltage with a reference voltage to generate a first current;
a zero adjuster, wherein the first current flows through the zero adjuster to generate a first voltage and a zero;
a second transconductance amplifier, generating the optical-coupling current based on the first voltage; and
a second resistor, coupled between the second transconductance and the optical coupler;
wherein the optical-coupling current flows through the second resistor.

19. The control circuit as claimed in claim 18, wherein when the divided voltage exceeds the reference voltage, the first transconductance amplifier increases the first current;
wherein when the divided voltage does not exceed the reference voltage, the first transconductance amplifier decreases the first current.

20. The control circuit as claimed in claim 18, wherein the zero adjuster comprises:
a zero resistor, coupled to the first voltage; and
a zero capacitor, coupled between the first zero resistor and a ground;
wherein the zero is configured to improve stability of the control circuit.
